(19) United States
(12) Patent Application Publication
(10) Pub. No.: US 2017/0001337 A1
(43) Pub. Date: Jan. 5, 2017

(54) DEVICE FOR REMOVING IMPURITIES FROM SHREDDEDS OF PLASTIC

(71) Applicant: CVP CLEAN VALUE PLASTIC GMBH, Hamburg (DE)

(72) Inventors: Michael Hofmann, Hamburg (DE); Alexander Gercke, Bad Oldesloe (DE)

(21) Appl. No.: 15/106,698

(22) PCT Filed: Dec. 1, 2014
(86) PCT No.: PCT/EP2014/076104

§ 371 Date: Jun. 20, 2016

(30) Foreign Application Priority Data
Dec. 20, 2013 (DE) 10 2013 114 699.6

(51) Int. Cl. B29B 17/02

(52) U.S. Cl. CPC B29B 17/02; B29B 2017/0289; B29K 2067/003

(57) ABSTRACT

The invention relates to a device for removing impurities from shredded plastic. The device comprises a first cleaning disk with a first cleaning surface, and a second cleaning disk with a second cleaning surface facing the first cleaning surface. A drive apparatus is configured to rotate at least one of the cleaning disks, and a feed apparatus is configured to feed the shredded plastic between the cleaning disks.

### CROSS REFERENCE TO RELATED APPLICATIONS

This application is a national stage application under 35 U.S.C. §371 of International Application No. PCT/EP2014/076104, filed Dec. 1, 2014, which claims priority to German Patent Application No. 10 2013 114 699.6, filed Dec. 20, 2013, the entire contents of each application being herein incorporated by reference.

### BACKGROUND OF THE INVENTION

The invention relates to a device for removing impurities from shredded plastic comprising a first cleaning disk with a first cleaning surface, and a second cleaning disk With a second cleaning surface, wherein the cleaning surfaces are opposite each other and delimit a cleaning gap between each other, furthermore comprising a drive apparatus by means of which at least one of the cleaning disks can rotate about its rotational axis, and a feed apparatus by means of which the shredded plastic can be fed between the cleaning disks.

Plastic waste such as polyethylene terephthalate (PET) beverage bottles, blister packages made of PET (thermoformed PET films), plastic waste consisting of polyolefins or the like, must be cleaned during recycling. Very high quality requirements must be satisfied. The permissible impurities fluctuate within the parts per million (ppm) range. For cleaning, the plastic waste is first comminuted into shredded plastic, in particular so-called plastic flakes. Shredded plastic that has been optimally comminuted beforehand is a requirement for the cleaning process and continuous feeding of a cleaning system. In particular, the shredded plastic should be generated as evenly as possible with a small amount of fines. It is known to use a shredder or cutting mills for this (a rotor with blades and opposing blades and a strainer basket). The generated flake size is influenced by the hole diameter in the strainer basket. Metals are removed from the plastic waste while pre-sorting by means of magnetic and eddy current separators. In the prior art, sorting according to colors and/or plastic types occurs before the comminution of the plastic waste. This is, however, associated with restrictions due to the contamination of the plastic waste since the identification rate of contaminated materials is less than with clean materials. Furthermore, several washing lines need to be operated when sorting before cleaning in order to clean the individual fractions. It is, however, also possible to first initially comminute plastic waste of different colors and/or different plastic types and then clean it, and only perform the sorting by colors and/or plastic types at the end of the process by means of color recognition, or respectively NIR, laser or x-ray spectroscopy. This can be done in an incident light process and/or a transillumination process with a suitable optical detector apparatus (camera).

When recycling plastic flakes, such as PET flakes, or polyethylene flakes, or respectively polypropylene flakes, the following requirements must be satisfied: 1. Removal of film and cellulose labels; 2. Removal of cellulose; 3. Cleaning contaminants arising from contents from the flakes (such as beverage residue); 4. Cleaning adhering contaminants from the flakes (such as adhesives from labels); 5. Removal of metals (such as corrugated metal and aluminum cans); 6. Removal of foreign plastics; 7. Sorting according to color (such as clear PET and colored PET).

Similar requirements (however with higher thresholds) apply to the mechanical recycling of other plastics such as non-transparent, solid color plastics. However, sorting according to color is generally omitted.

A generic device for removing impurities from shredded plastic is known from WO 2013/010654 A3. With the known device, a plurality of cleaning ribs is provided on each of the cleaning surfaces of the cleaning disks, wherein at least one flank of the cleaning ribs are angled or curved relative to the axial direction of the respective cleaning disk, and wherein a plurality of cleaning bars are arranged between at least some cleaning ribs that are adjacent to each other. In many applications, an outstanding cleaning result is achieved with this device. In some applications, in particular with stubborn impurities, and/or impurities that completely cover the individual shredded plastic caused for example by tough-elastic hot melt adhesives, the need nonetheless exists to further increase the cleaning power. At the same time, high energy efficiency should be achieved.

Based on the explained prior art, the object of the invention is therefore to provide a device of the initially-cited type by means of which the cleaning effect can be enhanced with a high level of energy efficiency.

The invention achieves the object with the subject matter of claim 1. Advantageous embodiments can be found in the dependent claims, the description and the figures.

### BRIEF SUMMARY OF THE INVENTION

For a device of the initially-cited type, the invention achieves the object in that the cleaning surfaces of the first and second cleaning disk each have a plurality of cleaning ribs running from an inner and outer radial position of the cleaning surfaces, wherein a gap is formed between adjacent cleaning ribs, and wherein a plurality of grooves is introduced into the surface of the cleaning ribs.

As noted above, the device serves to clean shredded plastic. As also noted above, the shredded plastic arises from the comminution of plastic waste, such as plastic packages like beverage bottles or the like. The shredded plastic comprises previously comminuted flat plastic waste which can exist in the form of flakes (thin-walled hard plastics, films, etc.) Or in the form of plastic chunks (thick-walled hard plastics) with a largely defined size. As also noted above, the impurities to be removed can in particular be surface adhesions such as residual cellulose, residual adhesive, residual labeling or organic contaminants. The shredded plastic can in particular be flat plastic pieces. In particular with plastic that is less tough such as high-density polyethylene (HDPE), a certain percentage of thicker plastic particles can also be included that are cleaned with the device according to the invention.

The device according to the invention possesses a first and second cleaning disk. The first and second cleaning disks can each have a (hollow) cylindrical basic shape. The cleaning surfaces facing each other can each be annular. The cleaning surfaces can be arranged over each other so that the cleaning surfaces each lie in a horizontal plane. The rotational axis of the at least one rotatably driven cleaning disk can simultaneously be its axis of symmetry. The rotational axis can run in a vertical direction. The drive can be an electric drive. As noted, it is possible for only one of the cleaning disks to be rotationally driven (rotor), whereas the other cleaning disk is not rotated (stator). The feed apparatus can introduce the shredded plastic centrally between the cleaning disks. The shredded plastic can then be conveyed from inside to outside through the cleaning gap, cleaned in the process, and be discharged out of the cleaning gap.

The cleaning disks of the device according to the invention have cleaning ribs that run between an inner and outer radial position of the cleaning surfaces. A gap is formed between each of the adjacent cleaning ribs, in particular between their peak surfaces. All or some of the cleaning ribs can extend from the outer edge of the cleaning surfaces, or respectively cleaning disks, up to the inner edge of the cleaning surfaces, or respectively cleaning disks. It is however also possible for the cleaning ribs to extend between the outer edge and inner edge of the cleaning surfaces, or respectively cleaning disks, but however to not extend completely up to the inner edge or outer edge. The inner and outer radial positions therefore do not necessarily have to be identical with the inner or outer edge of the cleaning surfaces, or respectively cleaning disks. To the extent that the cleaning disks are closed at the region of their center, the cleaning ribs can extend up to the center of the cleaning surfaces, or respectively cleaning disks. The cleaning ribs can have a straight trajectory or run in a curved direction. They can run in the radial direction over the respective cleaning surface. It is, however, also possible for them to run in a direction that is at an angle relative to the radial direction.

According to the invention, a plurality of grooves is furthermore introduced into the surface of the cleaning ribs. According to the invention, the surface of the cleaning ribs is therefore interrupted by the grooves. In principle, different cross-sectional geometries are possible for the grooves. For example, the grooves can possess a rectangular cross-section. It is however, e.g. also possible for the grooves to possess a V-shaped cross-section, or e.g. for only one flank that delimits the grooves to be angled relative to the vertical, whereas the other flank lies in a vertical plane, or for the width of the grooves to expand toward the groove base from their opening facing the cleaning gap. The last-cited embodiment prevents impurities from collecting in the grooves, in particular in the groove base. The number of provided grooves depends on the geometry of the cleaning disks and the spacing of the grooves relative to each other. These are parameters that can be selected depending on the respective application. There can however be provided e.g. more than 50 grooves, in particular more than 100 grooves, per cleaning rib.

The invention is based on the insight that it is advantageous to intentionally apply greater friction to the surface of the shredded plastic. For example, particularly stubborn impurities that are sheared off from increased friction, such as tough-elastic hot melt adhesives, can be more or less peeled off and are removed directly through the grooves; they therefore do not again adhere, or respectively smudge, the surface of the shredded plastic. The grooves scrape off impurities from the surfaces of the shredded plastic to be cleaned. The grooves introduced into the surface of the cleaning ribs in the form of slits accordingly result in more efficient removal of even the toughest impurities. The efficiency of the friction power and hence the energy efficiency of the overall device are significantly increased by the grooves. Experiments have revealed that a very narrow cleaning gap to increase the friction work on the surface of the shredded plastic leads to an excessively high energy consumption. The reason for this is that more energy has to be expended when the cleaning gap is narrow in order to pump water between the disks since the flow cross-section is narrow. By introducing the grooves according to the invention, the cleaning gap can be further narrowed to increase the friction work. At the same time, the grooves provide an additional flow cross-section which saves energy.

By suitably aligning the grooves, the dwell time of the shredded plastic in the gap can furthermore be increased which results in an improved cleaning effect, greater efficiency and therefore an improved energy balance. This can in particular be achieved by an oblique alignment of the grooves relative to the direction of extension of the cleaning ribs. In the prior art, the dwell time of the shredded plastic in the cleaning gap is inter alia extended by a direction of extension of the cleaning ribs that sometimes runs at a strong angle relative to the radial direction. However, this results in a significantly increased expenditure of energy; for this reason, the angle of the cleaning ribs relative to the radial direction should be restricted to an angle of, for example, a maximum of 60°, preferably a maximum of 45°, and more preferably a maximum of 30°. Due to the grooves according to the invention, the dwell time of the shredded plastic in the cleaning gap can nonetheless be significantly increased.

In addition, the cleaning surfaces can be serviced after becoming worn by easy-to-perform light surface grinding, wherein the edges of the grooves are automatically re-sharpened. This regrinding can in principle be performed several times. A limit is only posed by the required height of the cleaning ribs, in particular when cleaning bars are arranged between the cleaning ribs that, for example, are at a sufficient distance from the height of the cleaning ribs to let pass shredded plastic that takes up more space.

As already mentioned, the grooves can each run obliquely, i.e., at angle relative to the direction of extension of the cleaning ribs: This angle can in principle be selected depending on the respective application, i.e., the suspension consisting of liquid and shredded plastic to be cleaned that is introduced into the cleaning gap, and the geometry of the cleaning surfaces. It can for example be between −90° and 0°, in particular between −60° and −30°, or between 0° and 90°, in particular between 30° and 60°. It is furthermore possible for the grooves to run obliquely, or respectively at an angle relative to the direction of extension of the cleaning ribs so that when the cleaning surfaces rotate relative to each other, the direction of flow of liquid flowing through the cleaning gap is reversed by the grooves of at least one cleaning surface. When in this context an oblique path is mentioned, or a path of the grooves at an angle relative to the direction of extension of the cleaning ribs, this of course also includes the option of a curved path of the grooves and/or the cleaning ribs. In this case, an angle is formed that is defined by secants running through the starting point and end point of the relevant grooves, or respectively the relevant cleaning ribs. In the aforementioned embodiment, a reverse thrust is practically generated with regard to the flow of liquid through the cleaning gap. This increases inter alia the dwell time of the shredded plastic in the cleaning gap and enhances the cleaning effect. In addition, depending on the degree of contamination, the self-cleaning effect of the grooves is improved by appropriately selecting the intensity of the liquid flow. Depending on the nature of the shredded plastic to be cleaned, it may be advantageous to widen the groove cross-section toward its end in the longitudinal direction of the respective groove. While the device is operating, the groove cross-section can widen in the direction of flow through the grooves of the suspension consisting of the liquid and shredded plastic to be cleaned. The widening can in particular be opposite the direction of rotation of the relevant cleaning disk. This can prevent, for example, fine PET flakes from becoming wedged in the groove cross-section. By specifically enlarging the flow cross-section of the grooves in the direction of flow of the water stream, otherwise blocking plastic particles “float” free.

The gap between the adjacent cleaning ribs is in particular formed between the flanks of the cleaning ribs that face each other. The gap can for example have a V-shaped cross section. In principle, there can be a distance between the peak surfaces of adjacent cleaning ribs, both on the first cleaning surface as well as on the second cleaning surface, that substantially corresponds to the average thickness of the shredded plastic supplied by the feed apparatus. The cited distance between the peak surfaces of adjacent cleaning ribs at the location of their narrowest distance can be larger than the width of the peak surfaces of the adjacent cleaning ribs, such as 1.5 times larger. Removal of the liquid with the shredded plastic is thereby improved without the danger of a jam.

The direction of extension of the cleaning ribs between the inner and outer radial position can, as noted, run at an angle relative to the radial direction, such as an angle between −60° and 60°, preferably −45° and 45°, more preferably −30° and 30°. As already Mentioned, the direction of extension, or respectively the main direction of extension of the cleaning ribs when the path is curved, is defined by a secant running through the starting point of the cleaning ribs, in particular at the inner radial position, and the ending point of the cleaning ribs, in particular at the outer radial position. As also already mentioned at the onset, the dwell time of the shredded plastic in the cleaning gap, and hence the cleaning effect, is increased by this embodiment. Given the energy consumption that rises significantly with the angle, it is however advantageous for the angle not to be greater than 10°. Since however, the grooves provided according to the invention lead to a significant reduction in energy consumption, the angle can also be up to 60°, preferably up to 45°, and more preferably up to 80° given correspondingly designed grooves and in the case of some shredded plastic.

According to another embodiment, a first group of cleaning ribs can extend from an outer edge up to an inner edge of the respective cleaning surface, and a second group of cleaning ribs can extend from the outer edge up to an inner radial position at a distance from the inner edge of the respective cleaning surface, wherein the cleaning ribs of the second group are always arranged between the adjacent cleaning ribs of the first group. Given a significantly large distance between the cleaning ribs in the radially inner region of the cleaning surfaces that forms the inlet region, a sufficiently small distance between cleaning ribs in the radial outer region of the cleaning surfaces is thereby ensured providing for effective cleaning and preventing of jams. It is of course also possible for other groups of cleaning ribs to be formed, such as groups distributed as segments over the cleaning surface, wherein the cleaning ribs of a segment are always parallel to each other, but not parallel to the cleaning ribs of one or more of the other segments.

According to another embodiment, at least the cleaning ribs and grooves of the cleaning surfaces of the first and second cleaning disk are designed identically so that the grooves cross each other when cleaning surfaces face each other during operation, and while at least one cleaning disk is rotating. In particular, the two cleaning surfaces that face each other can be designed completely identical. By crossing the grooves, a shearing effect is created that further improves the cleaning of the shredded plastic, in particular when there are contaminants that adhere particularly strongly.

At least one flank of the cleaning ribs can be oblique or curved relative to the axial direction of the respective cleaning disk. The axial direction is formed by the axis of symmetry, or respectively the rotary axis of the respective cleaning disk. The corresponding flanks can hence each lie in a flat or curved surface. As noted, the axes of the cleaning disks can each run in a vertical direction. It is also possible for the two flanks of the cleaning ribs to be curved or angled relative to the axis of symmetry of the respective cleaning disk. The cleaning ribs of the first and/or second cleaning disk can also be rounded, at least at the transition between their at least one angled or curved flank and their peak surface. Furthermore, the cleaning ribs of the first and/or second cleaning disk can form a sawtooth profile in a peripheral direction around the center of the respective cleaning disk, or the respective cleaning surface.

The cleaning ribs of the first and/or second cleaning disk can possess a horizontal peak surface. The grooves can extend over the entire peak surface, and at least sectionally over the curved or oblique sides of the cleaning ribs. This further improves the cleaning effect by the grooves. According to another embodiment, the angled or curved flanks of the cleaning ribs of the first and/or second cleaning disk can be the leading flanks during a rotation of the respective cleaning disk.

The inner radial position of at least some cleaning ribs can be formed by the inner edge of the respective cleaning surface, or respectively cleaning disk, wherein at least these cleaning ribs rise starting from the inner edge to the outer edge like a ramp. A flat inlet zone for the liquid with the shredded plastic to be cleaned is thereby formed so that a jam at the inlet region into the cleaning gap can be reliably prevented.

According to another embodiment, a plurality of cleaning bars running perpendicular to the direction of extension of the cleaning ribs can be arranged between at least some cleaning ribs that are adjacent to each other. The cleaning bars can run perpendicular to the direction of extension of the cleaning ribs. However, they can also run in a direction perpendicular to the direction of extension of the cleaning ribs at an angle less or greater than 90° to the direction of extension of the cleaning ribs. The cleaning bars of the first and second cleaning disk can be arranged so that the cleaning bars of the first and second cleaning disk do not assume, or do not permanently assume, directly opposing positions while the at least one cleaning disk rotates. Furthermore, the cleaning bars can be arranged on the first and second cleaning surface along several circular paths around the center of the respective cleaning disk, or the respective cleaning surface. The circular paths of the cleaning bars on the first cleaning surface can possess different radii than the circular paths of the cleaning bars on the second cleaning surface. Furthermore, the cleaning bars can be arranged along the circular paths between each pair of adjacent cleaning ribs. At least some of the circular paths on the first cleaning surface and the circular paths on the second cleaning surface can have the same radius, wherein at least the cleaning bars along circular paths with the same radius are in each case arranged only between each second pair of adjacent cleaning ribs.

The cleaning bars of the first and/or second cleaning disk can rise in a ramp-like manner in the radial direction of the cleaning disks to the outside. Furthermore, the cleaning bats of the first cleaning disk can possess a lower height than the cleaning ribs of the first cleaning disk, and/or the cleaning bars of the second cleaning disk can possess a lower height than the cleaning ribs of the second cleaning disk. This embodiment also ensures that larger shredded plastic can also pass through.

In conjunction with the cleaning ribs designed as explained above, providing the cleaning bars designed as explained above yields an improved cleaning effect. This reduces the mechanical stress, in particular the compression, on the shredded plastic. In particular, folding or snarling the shredded plastic is avoided. The surfaces of the shredded plastic with the adhered components therefore remain accessible to cleaning. The shredded plastic is drawn between the cleaning ribs. The surface of the cleaning ribs generates a strong friction for cleaning the shredded plastic, in particular when interacting with the grooves.

The device according to the invention can furthermore have a liquid feed apparatus by means of which liquid, in particular water or an aqueous solution, can be fed into the cleaning gap.

### BRIEF DESCRIPTION OF THE DRAWINGS

An exemplary embodiment of the invention is explained in greater detail below based on figures. Schematically:

FIG. 1 shows a plan view of a section of a cleaning disk of a device according to the invention, and

FIG. 2 shows the section from FIG. 1 in a perspective view.

### DETAILED DESCRIPTION OF THE INVENTION

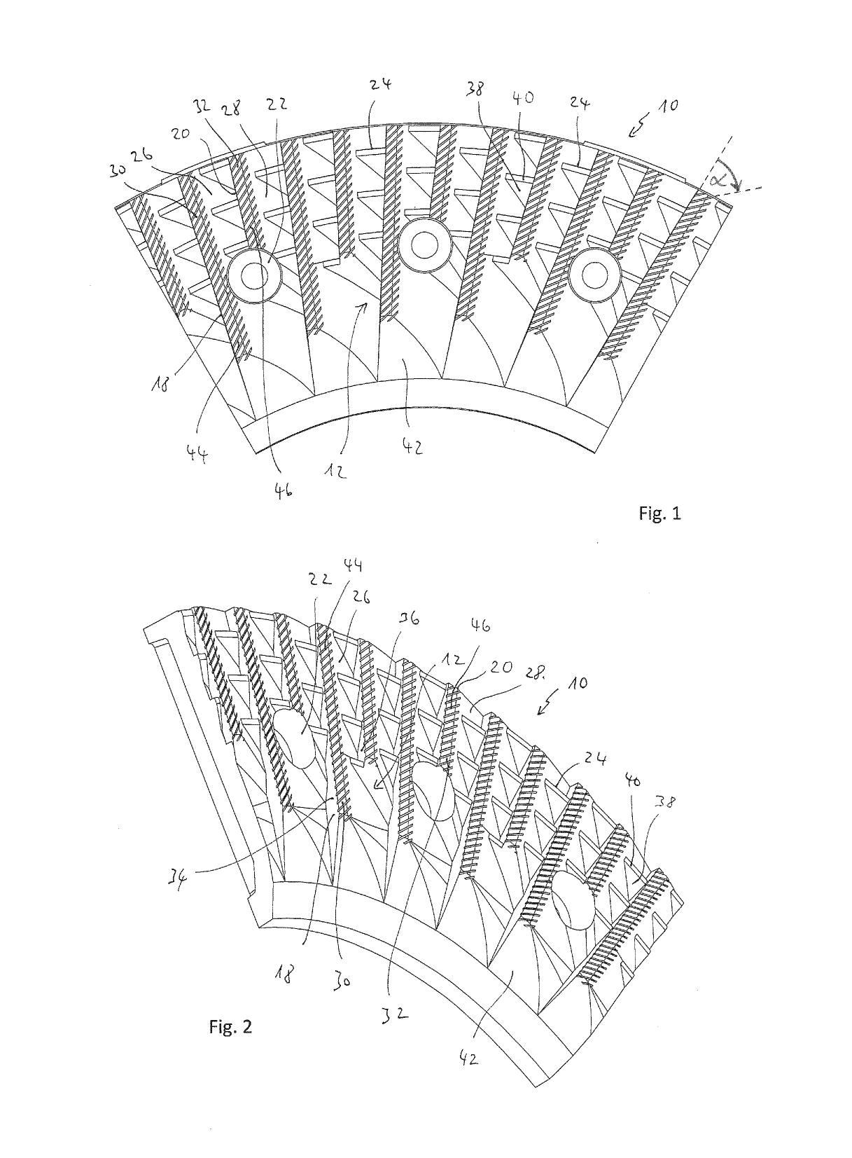

The same reference numbers refer to the same objects in the figures unless indicated otherwise. FIGS. 1 and 2 show a section of a cleaning disk 10 of a device according to the invention. The cleaning disk 10 in the portrayed example possesses a hollow cylindrical basic shape and an annular cleaning surface 12. The cleaning disk 10 can be composed of a plurality of cleaning disk segments, wherein FIGS. 1 and 2 can show such a segment. A plurality of cleaning ribs 18, 20 is arranged on the cleaning surface 12. The cleaning ribs 18 form a first group of cleaning ribs, and each extend completely between the inner edge and outer edge of the cleaning surface 12. The cleaning ribs 20 form a second group of cleaning ribs that extend from the outer edge of the cleaning surface 12 to an inner radial position that for example lies in the middle between the inner and outer edge. Reference sign 22 indicates openings that serve to attach the cleaning disk 10 to a support plate or similar. In the depicted example, the cleaning ribs 18, 20 run at angle of, for example, a maximum of 50° relative to the radial direction.

In the portrayed example, a plurality of cleaning bars 24 are furthermore arranged between all of the adjacent cleaning ribs 18, 20 and extend perpendicular to the direction of extension of the cleaning ribs 18, 20. As can be seen in FIGS. 1 and 2, the cleaning bars 24 are arranged in gaps formed between the cleaning ribs 18, 20. As can also be seen in FIGS. 1 and 2, the cleaning bars 24 of adjacent gaps are each arranged offset from each other in the radial direction. Two groups of cleaning bars 24 are then formed in this manner that each run along a plurality of concentric, circular paths around the center of the cleaning disk 10. The cleaning ribs 18, 20 furthermore possess a first flank 26, 28 that is oblique relative to the rotary axis of the cleaning disk 10 that runs vertically in the plane of the drawing in FIG. 1. On one side, the first flanks 26, 28 terminate in a horizontal peak surface 30, 32 of the cleaning ribs 18, 20. The horizontal peak surfaces 30, 32 in turn terminate in a second flank 34, 36 of the cleaning ribs 18, 20 (see FIG. 2). The second flanks 34, 36 lie in a vertical plane and are therefore not oblique relative to the rotary axis of the cleaning disk 10. Furthermore, it can be seen in the figures that the cleaning bars 24 each possess a surface 38 that rises ramp-like in a radial direction and terminates in a horizontal peak surface 40 of the cleaning bats 24. On the other hand, the surface of the cleaning bars 24 opposite the surface 38 is arranged in a vertical plane. In conclusion, it can be seen, for example in FIG. 2, that the height of the cleaning bars 24, in particular of their peak surfaces 40, is less than the height of the cleaning ribs 18, 20, in particular of their peak surfaces 30, 32. Furthermore at the inner edge of the cleaning disk 10, the cleaning ribs 18 of the first group each possess a section 42 that rises ramp-like in the radial direction of the cleaning disk 10, or respectively the cleaning surface 12.

In FIGS. 1 and 2, it can also be seen that a plurality of slot-like grooves 44, 46 is introduced into each surface of the cleaning ribs 18, 20. The grooves 44, 46 are arranged spaced evenly from each other, and each extend completely over the peak surfaces 30, 32 and sectionally into the sides 26, 28 of the cleaning ribs 18, 20. As can also be seen in FIG. 1, the grooves 44, 46 each run at an angle α to the direction of extension of the cleaning ribs 18, 20, formed in particular by the longitudinal axis of the peak surfaces 30, 32 of the cleaning ribs 18, 20. This angle α can for example be 45°. Depending on the field of use, other angles are of course also possible. Furthermore, it is also possible for some or all of the cleaning ribs of the first and/or second group 18, 20 and/or the grooves 44, 46 to have a curved path. In this case, any indicated angles refer to a secant running through the starting point and ending point.

Although only a section of one cleaning disk 10 is depicted in FIGS. 1 and 2, the device of course has a second cleaning disk that in particular can possess an identically designed cleaning surface with cleaning ribs 18, 20, cleaning bars 24 and grooves 44, 46 as explained above. During operation, the cleaning disks are arranged on top of each other such that the cleaning surfaces oppose each other and form a cleaning gap between them. At least one of the cleaning disks is rotatably driven by means of a drive (not shown), and particularly when the design of the cleaning surfaces of the cleaning disks is identical, the grooves 44, 46 cross each other during rotation and generate a shearing effect that improves cleaning. In addition, due to the oblique arrangement of the grooves 44, 46 a reversal occurs of the suspension of liquid and shredded plastic to be cleaned that is guided through the cleaning gap, at least in the region of one of the cleaning disks. Of course, the device for this purpose has a feed apparatus (not shown) for the shredded plastic and a liquid feed apparatus (also not shown) for the liquid.

1-17. (canceled)

18. A device for removing impurities from shredded plastic, the device comprising:
a first cleaning disk with a first cleaning surface having an outer edge and an inner edge;
a second cleaning disk with a second cleaning surface having an outer edge and an inner edge, wherein the first cleaning surface and the second cleaning surface face each other and delimit a cleaning gap between them, the first and second cleaning surfaces each further comprising:
a plurality of cleaning ribs extending along an axis between the outer edge and the inner edge; and
a plurality of grooves on at least one surface of each of the plurality of cleaning ribs;
a drive apparatus configured to rotate at least one of the cleaning disks about its rotational axis; and
a feed apparatus configured to feed shredded plastic between the first and second cleaning disks.

19. The device according to claim 18, wherein each of the plurality of grooves extends at an angle relative to the axis of a corresponding cleaning rib.

20. The device according to claim 19, wherein the angle is between −90° and 90°.

21. The device according to claim 18, wherein the plurality of cleaning ribs extend between the inner edge and the outer edge of a respective cleaning surface at an angle between −60° and 60° relative to a radial direction or each cleaning surface.

22. The device according to claim 18, wherein the plurality of cleaning ribs on at least one of the first and second cleaning disk include a horizontal peak surface.

23. The device according to claim 22, wherein a narrowest distance between the horizontal peak surfaces of adjacent cleaning ribs is larger than a width of the horizontal peak surfaces of the adjacent cleaning ribs.

24. The device according to claim 18, wherein a first group of cleaning ribs extends from the outer edge to the inner edge of a respective cleaning surface, and a second group of cleaning ribs extends from the outer edge to an inner radial position at a distance from the inner edge of the respective cleaning surface, wherein the cleaning ribs of the second group are arranged between adjacent cleaning ribs of the first group.

25. The device according to claim 18, wherein the plurality of cleaning ribs and the plurality of grooves of the first and second cleaning surface are configured so that the grooves cross each other when the first and second cleaning surfaces face each other during operation, and while at least one of the first and second cleaning disks is rotating.

26. The device according to claim 18, wherein at least one flank of the plurality of cleaning ribs is angled or curved relative to an axial direction of the respective cleaning disk.

27. The device according to claim 22, wherein the plurality of grooves extend across the peak surface.

28. The device according to claim 26, wherein the angled or curved flanks of the plurality of cleaning ribs of at least one of the first and second cleaning disks are leading flanks while at least one of the cleaning disks is rotating.

29. The device according to claim 24, wherein the inner radial position of at least some of the second group of cleaning ribs is formed by the inner edge of the respective cleaning surface.

30. The device according to claim 29, wherein the at least some of the first group and the second group of cleaning ribs rise in a ramp-like manner from the inner edge.

31. The device according to claim 18, wherein the first and second cleaning surfaces further comprise a plurality of cleaning bars extending from each of the plurality of cleaning ribs toward an adjacent cleaning rib.

32. The device according to claim 31, wherein the plurality of cleaning bars of at least one of the first and second cleaning surfaces rise in a ramp-like manner in a radial direction with respect to the at least one of the first and second cleaning surfaces.

33. The device according to claim 32, wherein the cleaning bars of the first cleaning disk are lower in height than the cleaning ribs of the first cleaning disk, and the cleaning bars of the second cleaning disk are lower in height than the cleaning ribs of the second cleaning disk.

34. The device according to claim 18, further comprising a liquid feed apparatus configured to feed liquid into the cleaning gap.
